(19) United States
(12) Patent Application Publication
(10) Pub. No.: US 2009/0080057 A1
(43) Pub. Date: Mar. 26, 2009

(54) COLOR WHEEL

(75) Inventor: KAI HUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/019,884

(22) Filed: Jan. 25, 2008

(30) Foreign Application Priority Data
Sep. 21, 2007 (CN) 200710201822.6

(51) Int. Cl. G02F 1/19

(52) U.S. Cl. 359/290

(57) ABSTRACT

A color wheel for use in a DLP projector includes a rotating disk, a color filter, a sensor, and a processor. The rotating disk has two end surfaces, a circumferential side surface extending between the two end surfaces, and a timing mark arranged on the side surface thereof. The color filter is mounted on an end surface of the rotating disk for jointly rotating with the rotating disk. The sensor faces toward the side surface of the rotating disk and is configured for determine a position of the timing mark relative to the color filter. The sensor has a casing defining a light inlet for receiving light reflected from the rotating portion. A shield is disposed around the light inlet of the sensor for preventing stray light coming into the sensor. The processor is electrically connected to the sensor for regarding the color index position of the color filter.

### TECHNICAL FIELD

The present invention relates to the art of a color wheel and, particularly, to a color wheel in a projection display device.

### DESCRIPTION OF RELATED ART

Referring to FIG. 2, a related color wheel 100 used in a digital light processing (DLP) projector (not shown) to separate light beams into three colors is provided. The color wheel 100 includes a rotating portion 20 of a motor (not shown), a color filter 10, a timing mark 40 adhered to the periphery of the rotating portion 20, a sensor 30 and a processor 25 electrically connected to the sensor 30.

The color filter 10 comprises a red filter segment 12, a blue filter segment 14 and a green filter segment 16. In general, the color filter 10 is mounted on the rotating portion 20 and rotated together with the rotating portion 20. The timing mark 40 is configured to aid the sensor 30 to detect a color index position of the color filter 10 during rotation. When portions of light beams 17 from the sensor 30 are projected onto the timing mark 40 of the rotating portion 20, they are absorbed by the timing mark 40, thereby the sensor 30 can detect the color index position of the color filter 10 because of not receiving a return reflection during the moments the timing mark 40 rotates through the fixed view of the sensor 30. The sensor 30 transmits the color index position to the processor 25 to drive a digital micromirror device (DMD). Clearly, successful operation of the DLP projector depends on properly synchronizing the red, blue, and green image data to the position of the timing mark 40 mounted on the rotating portion 20.

However, because light sources inside the projector usually provide very high intensity light beams, there will be a great deal of stray light 18 inside the projector. So, some of the stray light 18 may be coming into the sensor 30, with a result that the sensitivity of the sensor 30 is impacted, thereby synchronization between the processor 25 and the red, blue, and green image data of the color filter 10 is impacted as well.

What is needed, therefore, is a color wheel with reliable synchronization configuration.

### SUMMARY

In accordance with one present embodiment, a color wheel for use in a DLP projector includes a rotating disk, a color filter, a sensor, and a processor. The rotating disk has two end surfaces, a circumferential side surface extending between the two end surfaces, and a timing mark arranged on the side surface thereof. The color filter is mounted on an end surface of the rotating disk for jointly rotating with the rotating disk, the color filter including a plurality of sector-shaped filter segments attached to one another. The sensor faces toward the side surface of the rotating disk and is configured for emitting a light beam toward the side surface of the rotating disk and detecting light beam reflected from the side surface of the rotating disk so as to determine a position of the timing mark relative to the color filter. The sensor has a casing defining a light inlet for receiving light reflected from the rotating portion. A shield is disposed around the light inlet of the sensor for preventing stray light coming into the sensor. The processor is electrically connected to the sensor for regarding the color index position of the color filter and drive a digital micromirror device corresponding to the rotation of the color filter.

### BRIEF DESCRIPTION OF THE DRAWING

Many aspects of the present color wheel can be better understood with reference to the following drawings. The components in the drawing are not necessarily drawn to scale, the emphasis instead being placed upon clearly illustrating the principles of the present image capturing device. Moreover, in the drawings, like reference numerals designate corresponding parts throughout the several views.

FIG. 1 is a perspective view of a color wheel according to a present embodiment.

FIG. 2 is a perspective view of a related color wheel.

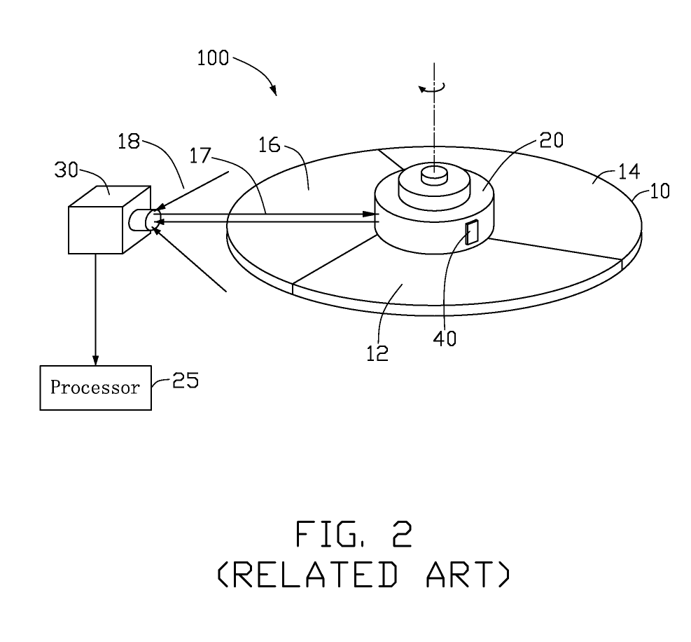

### DETAILED DESCRIPTION OF THE EMBODIMENTS

Embodiments will now be described in detail below, with reference to the drawings.

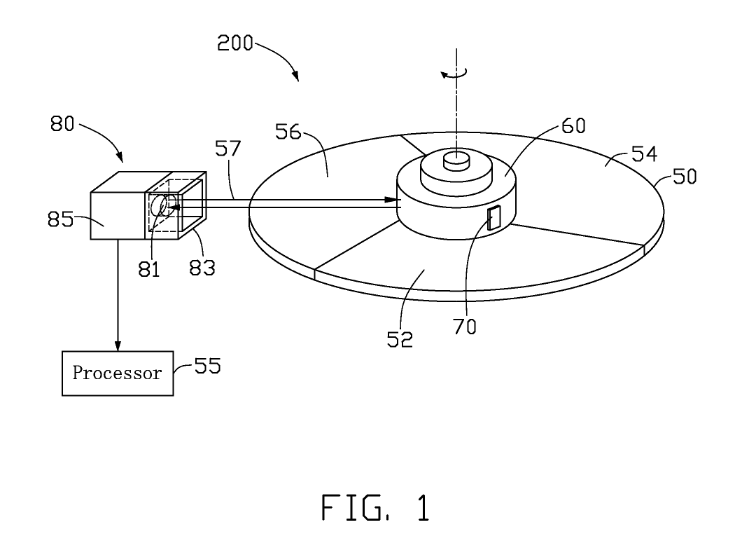

Referring to FIG. 1, a color wheel 200, in accordance with a present embodiment, includes a color filter 50, a motor (not shown) with a rotating disk 60, a processor 55, and a sensor 80. The sensor 80 is electrically coupled to the processor 55. The color wheel 200 is used in a digital light processing (DLP) projector (not shown) to separate light beams into three colors.

The color filter 50 has a transparent plate-configuration, beneficially, made from glass or quartz. The color filter includes a plurality of sector-shaped filter segments, such as a red filter segment 52, a green filter segment 54 and a blue filter segment 56. The contacting borders of the filter segments are adhered to one another by a glue and cooperatively form a through hole (not visible in FIG. 1) at the center thereof to facilitate mounting of the color filter 50 on the rotating disk 60, thereby the color filter 50 can rotate together with the rotating disk 60.

The rotating disk 60 has two end surfaces, a circumferential side surface extending between the two end surfaces, and a timing mark 70 arranged on the side surface thereof. The timing mark 70 is configured to aid the sensor 80 to detect a color index position of the color filter 50 mounted on an end surface of the rotating disk during rotation. When portions of light beams 57 from the sensor 80 are projected onto the timing mark 70 of the rotating disk 60, they are absorbed by the timing mark 70, thereby the sensor 80 can detect the color index position of the color filter 50 because of not receiving a return reflection during the moments the timing mark 70 rotates through the fixed view of the sensor 80. The timing mark 70 is made of a black or dark light-absorbent medium with low reflectivity.

The sensor 80 faces toward the side surface of the rotating disk 60. The sensor 80 is configured for emitting light beams 57 toward the side surface of the rotating disk 60 and detecting light beams 57 reflected from the side surface of the rotating disk 60 so as to determine a position of the timing mark 70 relative to the color filter 50. A diameter of the light beams 57 is less than that of the timing mark 70. The sensor 80 has a casing 85 defining a light inlet 81 for receiving light reflected from the rotating disk 60. A shield 83 is disposed around the light inlet 81 of the sensor 80 for preventing stray light inside the projection coming into the sensor 80. The shield 83 can be made of an opaque material, such as opaque plastic. Preferably, the inner surface of the shield 83 is covered with black material or the shield 83 is made of a black opaque material. The shield 83 can also be integrally formed with a casing 85 of the sensor 80.

The processor 55 is electrically connected to the sensor 80, and can process data from the sensor 80 regarding the color index position of the color filter 50 and drive a digital micromirror device corresponding to the rotation of the color filter 50.

The shield 83 can prevent stray light inside the projection coming into the sensor 80, thereby the sensor 80 can accurately detect the color index position of the color filter 50 accordingly and transmit that information to the processor 55. The processor 55 controls the timing of rotation of the color filter 50 to synchronize with light containing image data transmitted through the color filter 50. Thus, both a substantial synchronization and an accurate synthesization of color are obtained.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A color wheel for use in a DLP projector comprising:
a rotating disk having two end surfaces, a circumferential side surface extending between the two end surfaces, and a timing mark arranged on the side surface thereof;
a color filter mounted on an end surface of the rotating disk for jointly rotating with the rotating disk, the color filter including a plurality of sector-shaped filter segments attached to one another;
a sensor facing toward the side surface of the rotating disk, the sensor being configured for emitting a light beam toward the side surface of the rotating disk and detecting light beam reflected from the side surface of the rotating disk so as to determine a position of the timing mark relative to the color filter, the sensor having a casing defining a light inlet for receiving light reflected from the rotating portion, a shield disposed around the light inlet of the sensor for preventing stray light coming into the sensor; and
a processor electrically coupled to the sensor, the processor being configured for regarding the color index position of the color filter and drive a digital micromirror device corresponding to the rotation of the color filter.

2. The color wheel as claimed in claim 1, wherein the filter segments include a red filter segment, a green filter segment, and a blue filter segment.

3. The color wheel as claimed in claim 1, wherein the color filter has a transparent plate-configuration and is made from one of glass and quartz.

4. The color wheel as claimed in claim 1, wherein the sensor is configured emitting the light beam with a size thereof less than that of the timing mark.

5. The color wheel as claimed in claim 1, wherein the shield is made of an opaque material.

6. The color wheel as claimed in claim 5, wherein the shield is made of a plastic material.

7. The color wheel as claimed in claim 1, wherein the inner surface of the shield is covered with black material.

8. The color wheel as claimed in claim 1, wherein the shield is made of a black opaque material.

9. The color wheel as claimed in claim 1, wherein the shield is integrally formed with a casing of the sensor.
